(19) United States
(12) Patent Application Publication
(10) Pub. No.: US 2015/0092696 A1
(43) Pub. Date: Apr. 2, 2015

(54) METHOD AND APPARATUS FOR MANAGING RADIO BEARER FOR USER EQUIPMENT

(71) Applicant: Nokia Corporation, Espoo (FI)

(72) Inventors: Yang Liu, Beijing (CN); Haitao Li, Beijing (CN)

(21) Appl. No.: 14/398,564

(22) PCT Filed: May 21, 2012
(86) PCT No.: PCT/CN2012/075796

§ 371 Date: Nov. 3, 2014

(51) Int. Cl. H04W 72/04

(52) U.S. Cl. CPC H04W 72/04
USPC 370/329

(57) ABSTRACT

Methods, a first network node, a second network node, computer program products and apparatuses for managing radio bearer for user equipment are disclosed. In an exemplary embodiment, a method for managing radio bearer for user equipment in a first network node comprises: sending a radio bearer management request; receiving a radio bearer management response, the radio bearer management response indicating a radio bearer to be managed and comprising radio resource configuration information; generating a radio bearer management message based on the radio bearer to be managed; including the received radio resource configuration information into the generated radio bearer management message; ciphering and integrity protecting the radio bearer management message; and sending the secured radio bearer management message.

### TECHNICAL FIELD OF THE INVENTION

The present invention relates to a wireless communication system, and more particularly, to management of a radio bearer in 3^{rd} generation (3G) mobile communication system.

### BACKGROUND OF THE INVENTION

In 3G mobile communication systems, for example, Universal Mobile Telecommunications System (UMTS) or Long Term Evolution (LTE) system, when mobility management entity decides to manage (e.g. add, modify, release) data radio bearer for user equipment, a radio bearer management procedure is initiated. In response to receiving a radio access bearer setup/modify/release request from the mobility management entity, Node B (also referred to as “eNodeB” for the LTE system) configures the user equipment with related data radio bearer over air interface by sending radio resource control (RRC) connection reconfiguration message to the user equipment. The RRC connection reconfiguration message is ciphered and integrity protected using security keys by the Node B. The security keys are shared between the Node B and the user equipment.

LTE local area network (LTE-LAN) is the local area network utilizing LTE technology and more focused on local area use cases and scenarios. The LTE-LAN is intended to be deployed in a different band from LTE macro network but also in a licensed way. FIG. 1 shows a schematic diagram of an exemplary LTE-LAN system architecture. As shown in FIG. 1, the access point (shown as “LTE-LAN AP”) works under the macro eNodeB and is connected to the mobility management entity MME of core network through the macro eNodeB. So there is no direct interface between the LTE-LAN AP and the core network. Such LTE-LAN system can support both single-radio mode and dual-radio mode. In the single-radio mode, the user equipment (UE) only works with LTE-LAN radio and Evolved Packet System (EPS) service is provided via the LTE-LAN AP. In the dual-radio mode, the user equipment UE can work simultaneously with the LTE-LAN radio and LTE macro radio, and support both local IP service and the EPS service with different data paths.

In the LTE-LAN system shown as FIG. 1, when the user equipment UE is served by the LTE-LAN AP, during the radio bearer management procedure, the macro eNodeB will indicate the LTE-LAN AP of the radio bearer management. The LTE-LAN AP needs to inform the user equipment UE of the new radio resource configuration based on current LTE security rules. But the LTE-LAN AP may be provided by a third party and may not know the security keys of the LTE macro network. In this case, the LTE-LAN AP cannot provide cipher and/or integrity protection of the RRC connection reconfiguration message from the macro eNodeB. So the RRC connection reconfiguration message cannot be sent to the user equipment UE according to the current LTE security rules, and thus the LTE-LAN AP is not able to manage the radio bearer for the user equipment UE.

### SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

The present invention is directed to methods, a first network node, a second network node, computer program products and apparatuses for managing radio bearer for user equipment.

According to one embodiment, a method for managing radio bearer for user equipment in a first network node comprises: sending a radio bearer management request; receiving a radio bearer management response, the radio bearer management response indicating a radio bearer to be managed and comprising radio resource configuration information; generating a radio bearer management message based on the radio bearer to be managed; including the received radio resource configuration information into the generated radio bearer management message; ciphering and integrity protecting the radio bearer management message; and sending the secured radio bearer management message.

In an exemplary embodiment, the radio bearer management request can comprise an identifier of the user equipment, an identifier of at least one radio bearer, and configuration information for the at least one radio bearer.

In an exemplary embodiment, the radio bearer management request may be any one of a radio access bearer setup request, a radio access bearer modify request and a radio access bearer release request.

In an exemplary embodiment, the radio resource configuration information can comprise an identifier of data radio bearer, and at least one of Packet Data Convergence Protocol layer configuration information, Radio Link Control layer configuration information and logical channel configuration information.

In an exemplary embodiment, the radio bearer management message can be a radio resource control connection reconfiguration message.

In an exemplary embodiment, the first network node may be a NodeB or an eNodeB.

According to another embodiment, a method for managing radio bearer for user equipment in a second network node comprises: receiving a radio bearer management request; determining a radio bearer to be managed; allocating radio resource configuration information for the radio bearer to be managed; sending a radio bearer management response, the radio bearer management response indicating the radio bearer to be managed and comprising at least a part of the radio resource configuration information; receiving a secured radio bearer management message, the secured radio bearer management message comprising the at least a part of the radio resource configuration information; and handling the secured radio bearer management message with the determined radio resource configuration information for transmission to the user equipment.

In an exemplary embodiment, the radio resource configuration information can comprise an identifier of data radio bearer, and at least one of Packet Data Convergence Protocol layer configuration information, Radio Link Control layer configuration information, logical channel configuration information and Physical layer configuration information, and the at least a part of the radio resource configuration information can comprise the identifier of data radio bearer, and at least one of the Packet Data Convergence Protocol layer configuration information, the Radio Link Control layer configuration information and the logical channel configuration information.

In an exemplary embodiment, the secured radio bearer management message can be a radio resource control connection reconfiguration message which is ciphered and integrity protected.

In an exemplary embodiment, the second network node can be an access point.

According to another embodiment, a first network node comprises: at least one processor; and at least one memory including computer program code; the at least one memory and the computer program code configured to, with the at least one processor, cause the first network node to perform at least the following: sending a radio bearer management request; receiving a radio bearer management response, the radio bearer management response indicating a radio bearer to be managed and comprising radio resource configuration information; generating a radio bearer management message based on the radio bearer to be managed; including the received radio resource configuration information into the generated radio bearer management message; ciphering and integrity protecting the radio bearer management message; and sending the secured radio bearer management message.

According to another embodiment, a second network node comprises: at least one processor; and at least one memory including computer program code; the at least one memory and the computer program code configured to, with the at least one processor, cause the second network node to perform at least the following: receiving a radio bearer management request; determining a radio bearer to be managed; allocating radio resource configuration information for the radio bearer to be managed; sending a radio bearer management response, the radio bearer management response indicating the radio bearer to be managed and comprising at least a part of the radio resource configuration information; receiving a secured radio bearer management message, the secured radio bearer management message comprising the at least a part of the radio resource configuration information; and handling the secured radio bearer management message with the determined radio resource configuration information for transmission to the user equipment.

According to another embodiment, a computer program product comprises one or more sequences of one or more instructions which, when executed by one or more processors, cause an apparatus to at least perform the following: sending a radio bearer management request; receiving a radio bearer management response, the radio bearer management response indicating a radio bearer to be managed and comprising radio resource configuration information; generating a radio bearer management message based on the radio bearer to be managed; including the received radio resource configuration information into the generated radio bearer management message; ciphering and integrity protecting the radio bearer management message; and sending the secured radio bearer management message.

According to another embodiment, a computer program product comprises one or more sequences of one or more instructions which, when executed by one or more processors, cause an apparatus to at least perform the following: receiving a radio bearer management request; determining a radio bearer to be managed; allocating radio resource configuration information for the radio bearer to be managed; sending a radio bearer management response, the radio bearer management response indicating the radio bearer to be managed and comprising at least a part of the radio resource configuration information; receiving a secured radio bearer management message, the secured radio bearer management message comprising the at least a part of the radio resource configuration information; and handling the secured radio bearer management message with the determined radio resource configuration information for transmission to the user equipment.

According to another embodiment, an apparatus for managing radio bearer for user equipment in a first network node comprises: means for sending a radio bearer management request; means for receiving a radio bearer management response, the radio bearer management response indicating a radio bearer to be managed and comprising radio resource configuration information; means for generating a radio bearer management message based on the radio bearer to be managed; means for including the received radio resource configuration information into the generated radio bearer management message; means for ciphering and integrity protecting the radio bearer management message; and means for sending the secured radio bearer management message.

According to another embodiment, an apparatus for managing radio bearer for user equipment in a second network node comprises: means for receiving a radio bearer management request; means for determining a radio bearer to be managed; means for allocating radio resource configuration information for the radio bearer to be managed; means for sending a radio bearer management response, the radio bearer management response indicating the radio bearer to be managed and comprising at least a part of the radio resource configuration information; means for receiving a secured radio bearer management message, the secured radio bearer management message comprising the at least a part of the radio resource configuration information; and means for handling the secured radio bearer management message with the determined radio resource configuration information for transmission to the user equipment.

Generally, all terms used in this specification are to be interpreted according to their ordinary meaning in the technical field, unless explicitly defined otherwise herein. All references to “a/an/the [element, device, apparatus, component, means, step, etc]” are to be interpreted openly as referring to at least one instance of said element, device, apparatus, component, means, step, etc., unless explicitly stated otherwise. The steps of any method disclosed herein do not have to be performed in the exact order disclosed, unless explicitly stated.

Those skilled in the art will appreciate that the above is merely an introduction to the subject matter described in more detail below. Other objectives, features and advantages of the present invention will appear from the following detailed disclosure, from the attached dependent claims as well as from the drawings.

### BRIEF DESCRIPTION OF THE DRAWINGS

A more complete understanding of the present invention and certain advantages thereof may be acquired by referring to the following description in consideration of the accompanying drawings, in which like reference numbers indicate like features, and wherein:

FIG. 1 shows a schematic diagram of an exemplary LTE-LAN system architecture;

FIG. 2 is a flow chart illustrating the method for managing radio bearer for user equipment in a first network node according to an exemplary embodiment of the present invention;

FIG. 3 is a flow chart illustrating the method for managing radio bearer for user equipment in a second network node according to an exemplary embodiment of the present invention;

FIG. 4 is a signal chart illustrating the radio bearer management procedure in the LTE system in which the methods of the embodiments shown in FIGS. 2 and 3 may be implemented;

FIG. 5 is a schematic block diagram illustrating the first network node according to an exemplary embodiment of the present invention;

FIG. 6 is schematic block diagram illustrating the second network node according to an exemplary embodiment of the present invention.

### DETAILED DESCRIPTION OF THE EMBODIMENTS

In the following description of the various illustrative embodiments, reference is made to the accompanying drawings, which form a part thereof, and in which are shown by way of illustration various exemplary embodiments in which the invention may be practiced. It is to be understood that other embodiments may be utilized and structural and functional modifications may be made without departing from the scope of the present invention.

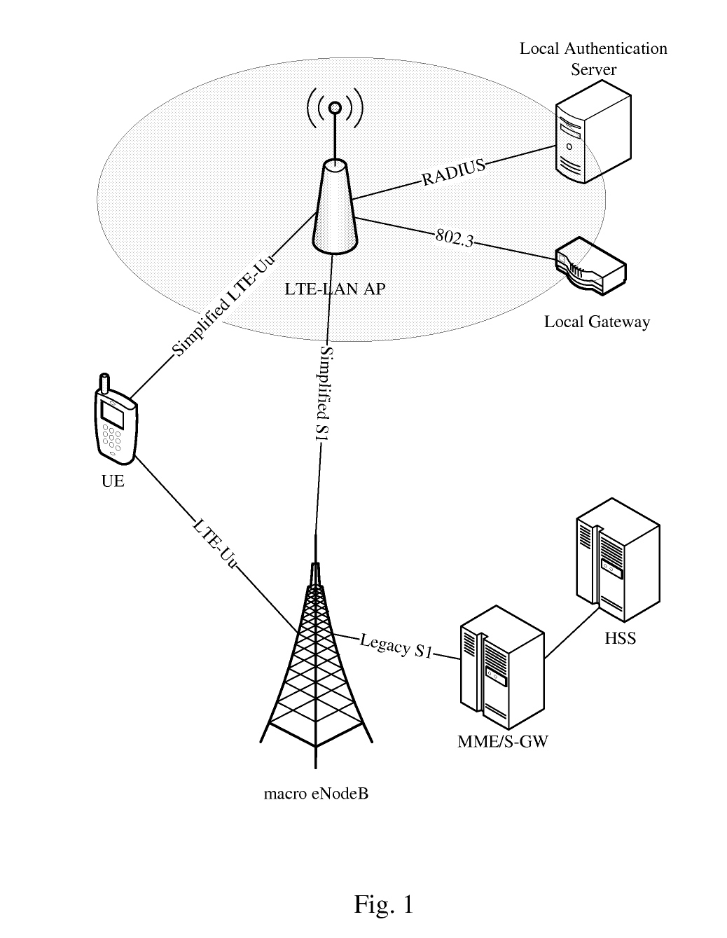

The various embodiments of the present invention can be applied to 3G mobile communication system, particularly, to the LTE system. For example, these embodiments can be implemented in the LTE-LAN system shown in FIG. 1.

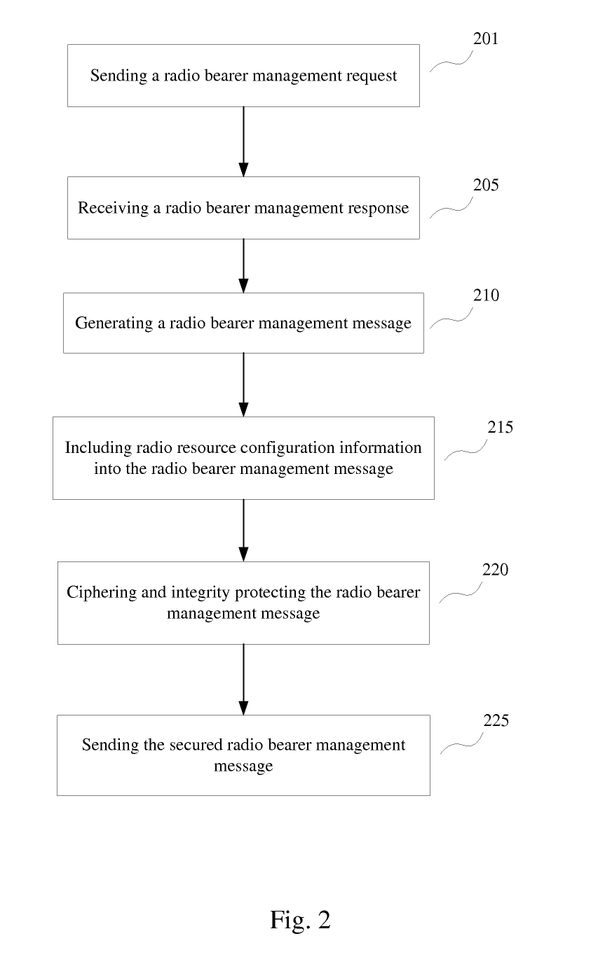

FIG. 2 is a flow chart illustrating the method for managing radio bearer for user equipment in a first network node according to an exemplary embodiment of the present invention. This embodiment will be described in detail in conjunction with the figure.

As shown in FIG. 2, at step S201, when the first network node decides to add/modify/release any radio bearer for user equipment, the first network node sends a radio bearer management request to initiate the radio bearer management procedure. Generally, the radio bearer management may comprise adding a radio bearer, modifying a radio bearer, and releasing a radio bearer. Accordingly, in an embodiment, the radio bearer management request may be any one of a radio access bearer setup request, a radio access bearer modify request and a radio access bearer release request. As an example, for LTE system, the radio bearer management request may be E-UTRAN Radio Access Bearer (E-RAB) setup request, or E-RAB modify request, or E-RAB release request. As another example, for UMTS system, the radio bearer management request may be Radio Access Bearer (RAB) setup request, or RAB modify request, or RAB release request.

Optionally, in another embodiment, the radio bearer management request comprises an identifier of the user equipment, an identifier of at least one radio bearer, and configuration information for the at least one radio bearer. The identifier of the user equipment indicates the user equipment for which radio bearer is to be added or modified or released. The radio bearer concerning the user equipment may be one or more than one, and can be presented in the form of a list. The configuration information for the radio bearer may comprise at least one of a priority of the radio bearer, a transmission rate of the radio bearer, service level for the radio bearer, and quality of service for the radio bearer, etc. Optionally, the radio bearer management request may comprise a transport address which indicates the address used for transmit the radio bearer management request. It can be appreciated for those skilled in the art that the radio bearer management request can also comprise other parameters.

Next, at step S205, the first network node receives a radio bearer management response, which is the response to the radio bearer management request. The radio bearer management response indicates a radio bearer to be managed and comprises radio resource configuration information. An admission control can be performed on the one or more radio bearers requested in the radio bearer management request to determine which radio bearer(s) would be admitted and which radio bearer(s) would be refused. The admitted radio bearer(s) becomes the radio bearer(s) to be managed. The result of the admission control can be contained in the radio bearer management response. In an embodiment, the radio resource configuration information is associated with a network node which sends the radio bearer management response, and may comprise an identifier of data radio bearer, and at least one of Packet Data Convergence Protocol (PDCP) layer configuration information, Radio Link Control (RLC) layer configuration information, and logical channel configuration information. For example, for the radio access bearer setup request, the radio resource configuration information may comprise the identifier of data radio bearer, the PDCP layer configuration information, the RLC layer configuration information, and the logical channel configuration information. For the radio access bearer modify request and the radio access bearer release request, the radio resource configuration information may comprise the identifier of data radio bearer and the PDCP layer configuration information and/or the RLC layer configuration information and/or the logical channel configuration information. It can be seen that the above-described radio resource configuration information is related to Layer 2, but those skilled in the art can understand that the configuration information of Layer 1 may also be comprised.

Thus, the first network node can obtain the admitted radio bearer and the related radio resource configuration information from the radio bearer management response. Then, at step S210, the first network node generates a radio bearer management message based on the admitted radio bearer. In an embodiment, the radio bearer management message is a radio resource control (RRC) connection reconfiguration message. At step S215, the first network node includes the received radio resource configuration information into the generated radio bearer management message. Then at step S220 the first network node ciphers and integrity protects the radio bearer management message using security keys. The security keys can be stored in the first network node and shared between the first network node and the user equipment. The ciphered and integrity protected radio bearer management message forms a PDCP protocol data unit (PDU). The first network node sends the PDCP PDU (i.e. the secured radio bearer management message) at step S225.

In an embodiment, the first network node can be a NodeB or an eNodeB.

It can be seen from the above description that, in this embodiment, the first network node can obtain the radio resource configuration information for the radio bearer, include it in the radio bearer management message, and cipher and integrity protects the radio bearer management message with the security keys, thereby securely protecting the radio resource configuration information to implement the management of the radio bearer for the user equipment.

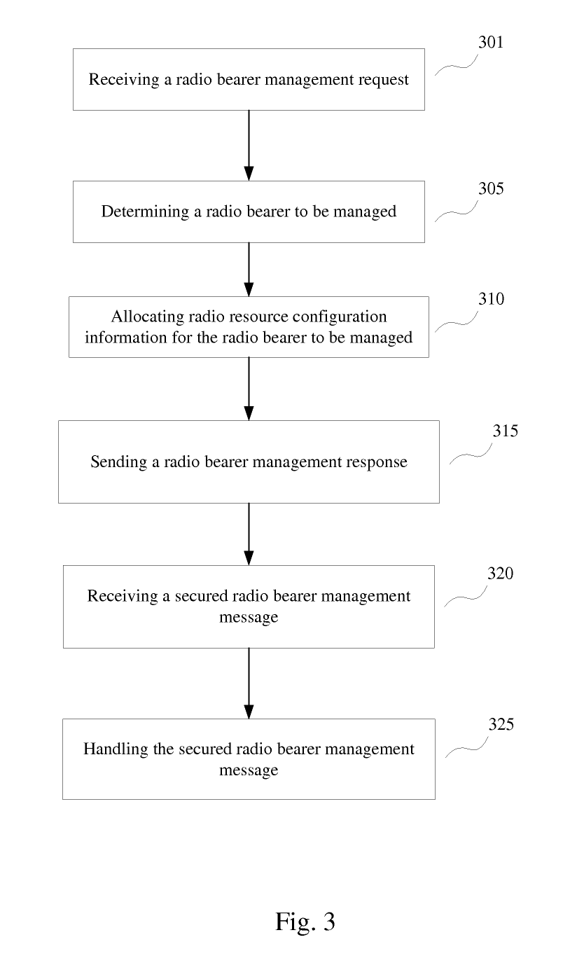

FIG. 3 is a flow chart illustrating the method for managing radio bearer for user equipment in a second network node according to an exemplary embodiment of the present invention. This embodiment will be described in detail in conjunction with the figure. For the parts which are same as those of the previous embodiment, the description thereof will be omitted properly.

As shown in FIG. 3, at step S301, the second network node receives a radio bearer management request, which indicates one or more than one radio bearers to be added, modified or released for the user equipment. As described above, the radio bearer management request may be any one of a radio access bearer setup request, a radio access bearer modify request and a radio access bearer release request.

Upon receiving the radio bearer management request, at step S305, the second network node determines a radio bearer to be managed. In an exemplary embodiment, an admission control can be performed on the requested one or more than one radio bearers to determine which radio bearer(s) would be admitted and which radio bearer(s) would be refused. The admitted radio bearer becomes the radio bearer to be managed. Then the second network node allocates radio resource configuration information for the admitted radio bearer(s) at step S310. In an embodiment, the radio resource configuration information may comprise an identifier of data radio bearer, and at least one of PDCP layer configuration information, RLC layer configuration information, logical channel configuration information and Physical layer configuration information. For the different radio bearer management request, the second network node can allocate different radio resource configuration information. For example, for the radio access bearer setup request, the radio resource configuration information may comprise the identifier of data radio bearer, the PDCP layer configuration information, the RLC layer configuration information, the logical channel configuration information, and the Physical layer configuration information. For the radio access bearer modify request and the radio access bearer release request, the radio resource configuration information may comprise the identifier of data radio bearer and the PDCP layer configuration information and/or the RLC layer configuration information and/or the logical channel configuration information and/or the Physical layer configuration information.

Next, the second network node puts the result of the admission control (e.g. the admitted radio bearer) and at least a part of the determined radio resource configuration information into a radio bearer management response, and sends the radio bearer management response at step S315. In an embodiment, the at least a part of the radio resource configuration information may comprise the identifier of data radio bearer, and at least one of the PDCP layer configuration information, the RLC layer configuration information and the logical channel configuration information, i.e. the Layer 2 configuration information. It can be appreciated for those skilled in the art that all the radio resource configuration information determined by the second network node may be sent in the radio bearer management response.

At step S320, the second network node receives a secured radio bearer management message, which comprises the at least a part of the radio resource configuration information. In an embodiment, the secured radio bearer management message can be a RRC connection reconfiguration message which is ciphered and integrity protected. For the second network node, the secured RRC connection reconfiguration message is received as a PDCP PDU. Then the second network node, at step S325, handles the secured radio bearer management message with the determined radio resource configuration information. In an embodiment, the second network node processes the PDCP PDU with the RLC layer, MAC layer and Physical layer, thereby transmitting the secured radio resource configuration information to the user equipment.

In an exemplary embodiment, the second network node can be an access point.

It can be seen from the above description that, in this embodiment, the second network node is able to manage the radio bearer for the user equipment using the secured radio bearer management message such as RRC connection reconfiguration message, by allocating the radio resource configuration information for the radio bearer to be managed and handling the secured radio bearer management message with Layer 2 and Layer 1. Moreover, the second network node does not provide cipher and integrity protect the radio bearer management message by itself, so the security of the radio resource configuration information would not be affected even if the second network node cannot derive any security key.

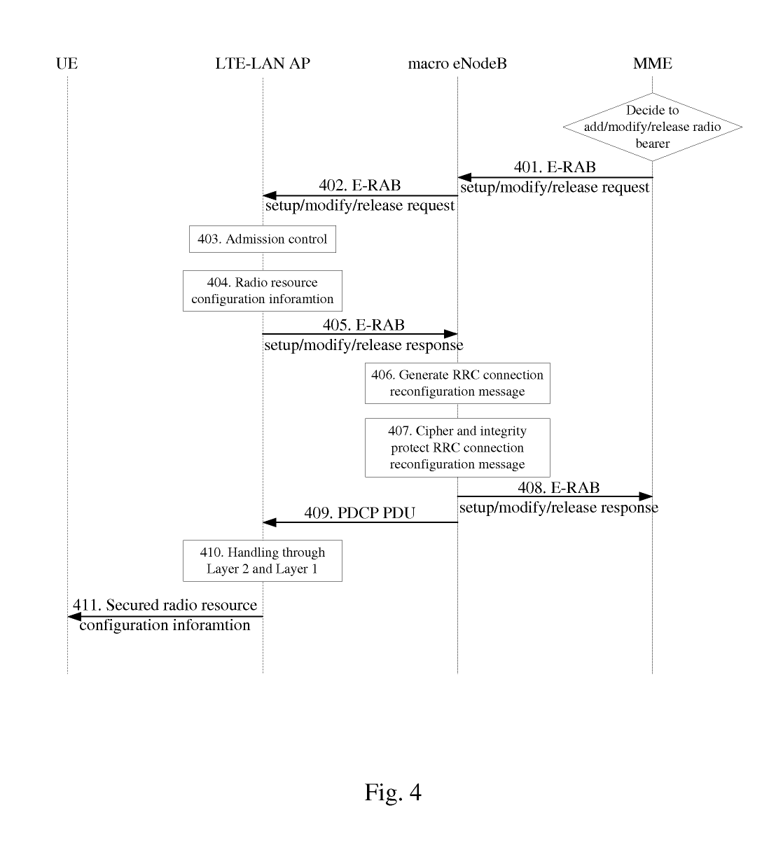

FIG. 4 is a signal chart illustrating the radio bearer management procedure in the LTE system in which the methods of the embodiments shown in FIGS. 2 and 3 may be implemented.

Assume the LTE system is as shown in FIG. 1, the macro eNodeB is acted as the first network node, the LTE-LAN AP is acted as the second network node, and EPS service is going on through the LTE-LAN AP. Thus, the macro eNodeB can implement the method as shown in FIG. 2, and the LTE-LAN AP can implement the method as shown in FIG. 3.

As shown in FIG. 4, the MME decides to add/modify/release the radio bearer for the user equipment UE, and sends an E-RAB setup/modify/release request to the macro eNodeB (at 401). In response to receiving the E-RAB setup/modify/release request, the macro eNodeB generates the corresponding E-RAB setup/modify/release request and sends it to the LTE-LAN AP (at 402). The E-RAB setup/modify/release request comprises an E-RAB list for the user equipment UE which comprises one or more E-RABs. After receiving the E-RAB setup/modify/release request, the LTE-LAN AP performs the admission control and admits all or part of the requested E-RABs (at 403). At this point, the LTE-LAN AP also allocates the radio resource configuration information for the admitted E-RABs (at 404). The radio resource configuration information may comprise the identifiers of the data radio bearers associated with the admitted E-RABs, and Layer 2 configuration information (including at least one of PDCP layer configuration information, RLC layer configuration information, and logical channel configuration information) and/or Layer 1 configuration information (i.e. Physical layer configuration information). Then the LTE-LAN AP sends the E-RAB setup/modify/release response comprising the admitted E-RABs and the Layer 2 configuration information to the macro eNodeB (at 405). The macro eNodeB generates the RRC connection reconfiguration message using information of the admitted E-RABs, and comprises the Layer 2 configuration information into the RRC connection reconfiguration message (at 406). Then the macro eNodeB ciphers and integrity protects the RRC connection reconfiguration message in PDCP layer with the security keys to form a PDCP PDU. The security keys are stored in the macro eNodeB and shared between the macro eNodeB and the user equipment UE (at 407). The macro eNodeB sends the E-RAB setup/modify/release response indicating the result of the admission control to the MME (at 408), and sends the secured RRC connection reconfiguration message as the PDCP PDU to the LTE-LAN AP (at 409). Upon receipt of the secured RRC connection reconfiguration message, the LTE-LAN AP handles the PDCP PDU with RLC layer, MAC layer and Physical layer (at 410), and issues the secured radio resource configuration information to the user equipment UE (at 411) to add/modify/release the related radio bearer(s).

In this way, the LTE-LAN AP can manage the radio bearer of the user equipment UE. Since the eNodeB ciphers and integrity protects the RRC connection reconfiguration message using the security keys derived in the LTE macro network, the radio bearer of the user equipment UE can be kept in the same security level as in the LTE macro network.

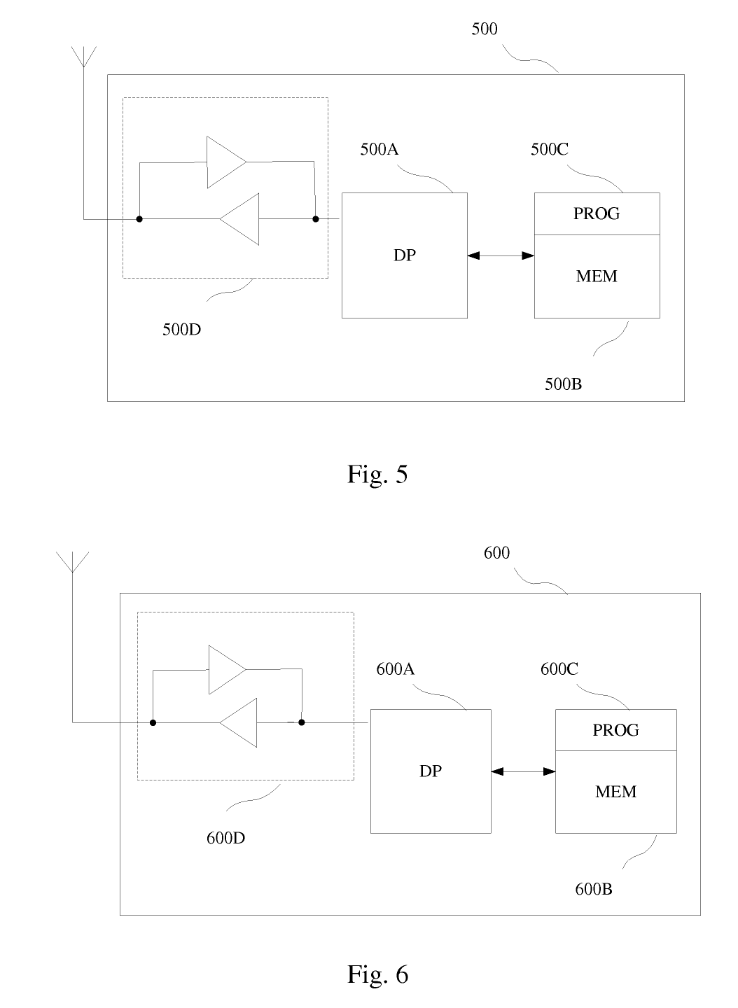

FIG. 5 is a schematic block diagram illustrating the first network node 500 according to an exemplary embodiment of the present invention. In FIG. 5, the first network node 500 may comprise a data processor (DP) 500A, a memory (MEM) 500B that stores a program (PROG) 500C, a transceiver 500D and an antenna.

At least one of the PROG 500C is assumed to comprise program instructions that, when executed by the associated DP 500A, enable the first network node 500 to operate in accordance with the exemplary embodiment of the method shown in FIG. 2, as discussed above. That is, the exemplary embodiment of the method shown in FIG. 2 may be implemented at least in part by computer software executable by the DP 500A of the first network node 500, or by hardware, or by a combination of software and hardware.

FIG. 6 is a schematic block diagram illustrating the second network node 600 according to an exemplary embodiment of the present invention. In FIG. 6, the second network node 600 may comprise a data processor (DP) 600A, a memory (MEM) 600B that stores a program (PROG) 600C, a transceiver 600D and an antenna.

At least one of the PROG 600C is assumed to comprise program instructions that, when executed by the associated DP 600A, enable the second network node 600 to operate in accordance with the exemplary embodiment of the method shown in FIG. 3, as discussed above. That is, the exemplary embodiment of the method shown in FIG. 3 may be implemented at least in part by computer software executable by the DP 600A of the second network node 600, or by hardware, or by a combination of software and hardware.

The MEM 500B, 600B may be of any type suitable to the local technical environment and may be implemented using any suitable data storage technology, such as semiconductor based memory devices, flash memory, magnetic memory devices and systems, optical memory devices and systems, fixed memory and removable memory. The DP 500A, 600A may be of any type suitable to the local technical environment, and may comprise one or more of general purpose computers, special purpose computers, microprocessors, digital signal processors (DSPs) and processors based on multi-core processor architectures, as non-limiting examples.

Alternatively or optionally, according to an exemplary embodiment of the invention, an apparatus for managing radio bearer for user equipment in a first network node is provided, which comprises: means for sending a radio bearer management request; means for receiving a radio bearer management response, the radio bearer management response indicating a radio bearer to be managed and comprising radio resource configuration information; means for generating a radio bearer management message based on the radio bearer to be managed; means for including the received radio resource configuration information into the generated radio bearer management message; means for ciphering and integrity protecting the radio bearer management message; and means for sending the secured radio bearer management message.

Alternatively or optionally, according to an exemplary embodiment of the invention, an apparatus for managing radio bearer for user equipment in a second network node is provided, which comprises: means for receiving a radio bearer management request; means for determining a radio bearer to be managed; means for allocating radio resource configuration information for the radio bearer to be managed; means for sending a radio bearer management response, the radio bearer management response indicating the radio bearer to be managed and comprising at least a part of the radio resource configuration information; means for receiving a secured radio bearer management message, the secured radio bearer management message comprising the at least a part of the radio resource configuration information; and means for handling the secured radio bearer management message with the determined radio resource configuration information for transmission to the user equipment.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the invention may be practiced in various components such as integrated circuit chips and modules. It should thus be appreciated that the exemplary embodiments of this invention may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this invention.

It should be appreciated that at least some aspects of the exemplary embodiments of the inventions may be embodied in computer-executable instructions, such as in one or more program modules, executed by one or more computers or other devices. Generally, program modules comprise routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by those skilled in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

The present invention comprises any novel feature or combination of features disclosed herein either explicitly or any generalization thereof. Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

1-36. (canceled)

37. A method for managing radio bearer for a user equipment in a first network node, comprising:
sending a radio bearer management request;
receiving a radio bearer management response, the radio bearer management response indicating a radio bearer to be managed and comprising radio resource configuration information;
generating a radio bearer management message based on the radio bearer to be managed;
including the received radio resource configuration information into the generated radio bearer management message;
ciphering and integrity protecting the radio bearer management message; and
sending the secured radio bearer management message.

38. The method according to claim 37, wherein the radio bearer management request comprises an identifier of the user equipment, an identifier of at least one radio bearer, and configuration information for the at least one radio bearer.

39. The method according to claim 37, wherein the radio bearer management request is any one of a radio access bearer setup request, a radio access bearer modify request and a radio access bearer release request.

40. The method according to claim 37, wherein the radio resource configuration information comprises an identifier of a data radio bearer, and at least one of Packet Data Convergence Protocol layer configuration information, Radio Link Control layer configuration information and logical channel configuration information.

41. The method according to claim 37, wherein the radio bearer management message is a radio resource control connection reconfiguration message.

42. The method according to claim 37, wherein the first network node is a NodeB or an eNodeB.

43. A first network node, comprising:
at least one processor; and
at least one memory including computer program code;
the at least one memory and the computer program code configured to, with the at least one processor, cause the first network node to perform at least the following:
send a radio bearer management request;
receive a radio bearer management response, the radio bearer management response indicating a radio bearer to be managed and comprising radio resource configuration information;
generate a radio bearer management message based on the radio bearer to be managed;
include the received radio resource configuration information into the generated radio bearer management message;
cipher and integrity protecting the radio bearer management message; and
send the secured radio bearer management message.

44. The first network node according to claim 43, wherein the radio bearer management request comprises an identifier of a user equipment, an identifier of at least one radio bearer, and configuration information for the at least one radio bearer.

45. The first network node according to claim 43, wherein the radio bearer management request is any one of a radio access bearer setup request, a radio access bearer modify request and a radio access bearer release request.

46. The first network node according to claim 43, wherein the radio resource configuration information comprises an identifier of a data radio bearer, and at least one of Packet Data Convergence Protocol layer configuration information, Radio Link Control layer configuration information and logical channel configuration information.

47. The first network node according to claim 43, wherein the radio bearer management message is a radio resource control connection reconfiguration message.

48. The first network node according to claim 43, wherein the first network node is a NodeB or an eNodeB.

49. A second network node, comprising:
at least one processor; and
at least one memory including computer program code;
the at least one memory and the computer program code configured to, with the at least one processor, cause the second network node to perform at least the following:
receive a radio bearer management request;
determine a radio bearer to be managed;
allocate radio resource configuration information for the radio bearer to be managed;
send a radio bearer management response, the radio bearer management response indicating the radio bearer to be managed and comprising at least a part of the radio resource configuration information;
receive a secured radio bearer management message, the secured radio bearer management message comprising the at least a part of the radio resource configuration information; and
handle the secured radio bearer management message with the determined radio resource configuration information for transmission to a user equipment.

50. The second network node according to claim 49, wherein the radio bearer management request comprises an identifier of the user equipment, an identifier of at least one radio bearer, and configuration information for the at least one radio bearer.

51. The second network node according to claim 49, wherein the radio bearer management request is any one of radio access bearer setup request, radio access bearer modify request and radio access bearer release request.

52. The second network node according to claim 49, wherein the radio resource configuration information comprises an identifier of a data radio bearer, and at least one of Packet Data Convergence Protocol layer configuration information, Radio Link Control layer configuration information, logical channel configuration information and Physical layer configuration information, and
wherein the at least a part of the radio resource configuration information comprises the identifier of data radio bearer, and the at least one of the Packet Data Convergence Protocol layer configuration information, the Radio Link Control layer configuration information and the logical channel configuration information.

53. The second network node according to claim 49, wherein the secured radio bearer management message is a radio resource control connection reconfiguration message which is ciphered and integrity protected.

54. The second network node according to claim 49, wherein the second network node is an access point.
